(19) United States
(12) Patent Application Publication
(10) Pub. No.: US 2021/0031796 A1
(43) Pub. Date: Feb. 4, 2021

(54) VEHICLE OPERATION SYSTEM

(71) Applicant: TOYOTA JIDOSHA KABUSHIKI KAISHA, Toyota-shi (JP)

(72) Inventors: Miyako HAYASHIDA, Miyoshi-shi (JP); Toshinari OGAWA, Nagoya-shi (JP); Kosuke FUJIMOTO, Nisshin-shi (JP); Hideo HASEGAWA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/894,940

(22) Filed: Jun. 8, 2020

(30) Foreign Application Priority Data
Aug. 1, 2019 (JP) 2019-142415

(51) Int. Cl. B60W 60/00; G05D 1/00; G06K 9/00

(52) U.S. Cl. CPC B60W 60/005; G05D 1/0022; B60W 2556/45; G06K 9/00791; G05D 1/0044

(57) ABSTRACT

A vehicle operation system including: plural vehicles; an acquiring section that acquire information of the vehicles; a deciding section that sets an operation right to enable operation of the vehicle for a first or a second operator that carries out operation of the vehicle by remote operation; an information providing section that, when the first or the second operator carries out remote operation of the vehicle, provides the information for the first operator or the second operator; a remote operation control section that, when the first or the second operator carries out remote operation of the vehicle, causes the vehicle to be operated by remote operation by operation of the first operator or the second operator; and a monitoring section that, at a time of remote operation of the vehicle, transfers the operation right to another of the first operator and the second operator when determined necessary.

### CROSS-REFERENCE TO RELATED APPLICATION

This application claims priority under 35 USC 119 from Japanese Patent Application No. 2019-142415, filed on Aug. 1, 2019, the disclosure of which is incorporated by reference herein.

### BACKGROUND

### Technical Field

The present disclosure relates to a vehicle operation system.

### Related Art

Japanese Patent Application Laid-Open (JP-A) No. 2019-104287, discloses a remote operation system of a vehicle. In this remote operation system of a vehicle, by using an operation device that is provided at the exterior of the vehicle, a vehicle that is to be the subject of operation is selected from among plural vehicles, and that vehicle is operated remotely.

However, JP-A No. 2019-104287, does not disclose addressing cases in which the vehicle that is being remotely operated drives into an area where vehicle entry is prohibited (hereinafter simply called a “prohibited area”), or cases in which the remote operator suspends the remote operation. There is therefore the possibility that the vehicle will fall into a precarious situation, and there is room for improvement over the aforementioned conventional technology with regard to this point.

### SUMMARY

The present disclosure provides a vehicle operation system in which a vehicle, which is being operated remotely, falling into a precarious situation may be suppressed.

A first aspect of the present disclosure is a vehicle operation system including: plural vehicles that are respectively located at plural places; an acquiring section configured to acquire information of the vehicles including images of peripheries of the vehicles; a deciding section configured to set an operation right to enable operation of the vehicle, for either a first operator or a second operator that carries out operation of the vehicle by remote operation; an information providing section configured to, in a case in which the first operator or the second operator, for whom the operation right has been set by the deciding section, carries out operation of the vehicle by remote operation, provide the information acquired by the acquiring section to the first operator or the second operator who has been given the operation right; a remote operation control section configured to, in a case in which the first operator or the second operator, for whom the operation right has been set by the deciding section, carries out operation of the vehicle by remote operation, causes the vehicle to operate by remote operation by operation of the first operator or the second operator; and a monitoring section configured to, at a time of remote operation of the vehicle by the first operator or the second operator, transfers the operation right to another of the first operator and the second operator when determined necessary.

In accordance with the first aspect of the present disclosure, the vehicle operation system has plural vehicles, an acquiring section, a deciding section, an information providing section, a remote operation control section and a monitoring section. The plural vehicles are respectively located at plural places. The acquiring section acquires information including images of the situations at the respective peripheries of the plural vehicles. The deciding section gives an operation right, which enables operation of a vehicle, to either of a first operator or a second operator. When the operation right is granted, at least one of the first operator and the second operator operates the vehicle by remote operation via the remote operation control section. In a case in which the first operator or the second operator, to whom the operation right has been given by the deciding section, operates the vehicle by remote operation, the information providing section provides the information of the vehicle, which is acquired by the acquiring section, to the remote operator. Due thereto, at the time when the first operator or the second operator carries out remote operation, that operator can operate the vehicle while perceiving the situation at the periphery of the vehicle.

Further, at the time when either one of the first operator and the second operator remotely operates the vehicle, the monitoring section transfers the operation right of the vehicle to the other of the first operator and the second operator when determining it to be necessary. Accordingly, at the time of remote operation by either one of the first operator and the second operator, in a case in which a state arises in which remote operation of the vehicle cannot be carried out, or in a case in which a precarious situation arises such as the vehicle drives into a precarious area or the like, the vehicle may be operated appropriately by operation of the other of the first operator and the second operator.

In a second aspect of the present disclosure, in the above first aspect, the deciding section may further be configured to set a manager authority for either one of the first operator and the second operator, and the monitoring section may further be configured to prioritize transfer of the operation right of the vehicle to the one of the first operator and the second operator who has been given the manager authority.

In accordance with the second aspect of the present disclosure, the monitoring section prioritarily transfers the operation right of the vehicle to the one of the first operator and the second operator who has been given the manager authority by the deciding section. Therefore, in a case in which the vehicle falls into a precarious situation at the time of remote operation, the operator who has the manager authority can operate the vehicle. Accordingly, the vehicle may be set in a more appropriate state.

In a third aspect of the present disclosure, in the above first aspect or second aspect, the monitoring section may notify an outside when determining it to be necessary.

In accordance with the third aspect of the present disclosure, because the monitoring section notifies to outside when determining it to be necessary, it is easy to receive notification and to change the vehicle over to an appropriate state. Namely, the third aspect of the present disclosure may suppress the continuing of a precarious situation at the vehicle.

The vehicle operation system relating to the first aspect of the present disclosure may suppress a vehicle, which is being remotely-operated, falling into a precarious situation.

In the vehicle operation system relating to the second aspect of the present disclosure, managing of the vehicles may become easy.

The vehicle operation system relating to the third aspect of the present disclosure may suppress a vehicle, which is being remotely-operated, falling into a precarious situation precarious situation even more.

### BRIEF DESCRIPTION OF THE DRAWINGS

Exemplary embodiments will be described in detail based on the following figures, wherein:

FIG. 1 is a schematic drawing illustrating an overview of a vehicle operation system relating to an exemplary embodiment;

FIG. 2 is a block drawing illustrating hardware configurations of a vehicle of the vehicle operation system relating to the exemplary embodiment;

FIG. 3 is a block drawing illustrating hardware configurations of a user terminal device of the vehicle operation system relating to the exemplary embodiment;

FIG. 4 is a block drawing illustrating hardware configurations at a control center of the vehicle operation system relating to the exemplary embodiment;

FIG. 5 is a block drawing illustrating hardware configurations at a server of the vehicle operation system relating to the exemplary embodiment;

FIG. 6 is a block drawing illustrating functional configurations of the vehicle operation system relating to the exemplary embodiment; and

FIG. 7 is a flowchart illustrating the flow of operations of the vehicle operation system relating to the exemplary embodiment.

### DETAILED DESCRIPTION

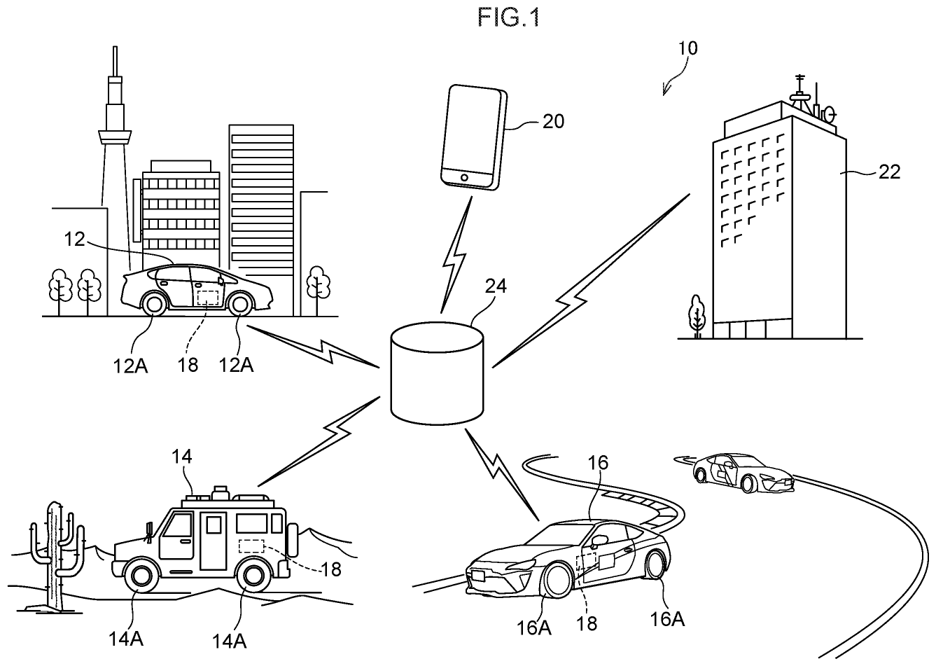

An exemplary embodiment of a vehicle operation system 10 relating to the present disclosure is described hereinafter by using FIG. 1 through FIG. 7.

FIG. 1 is a drawing illustrating the schematic configuration of the vehicle operation system 10 relating to the exemplary embodiment.

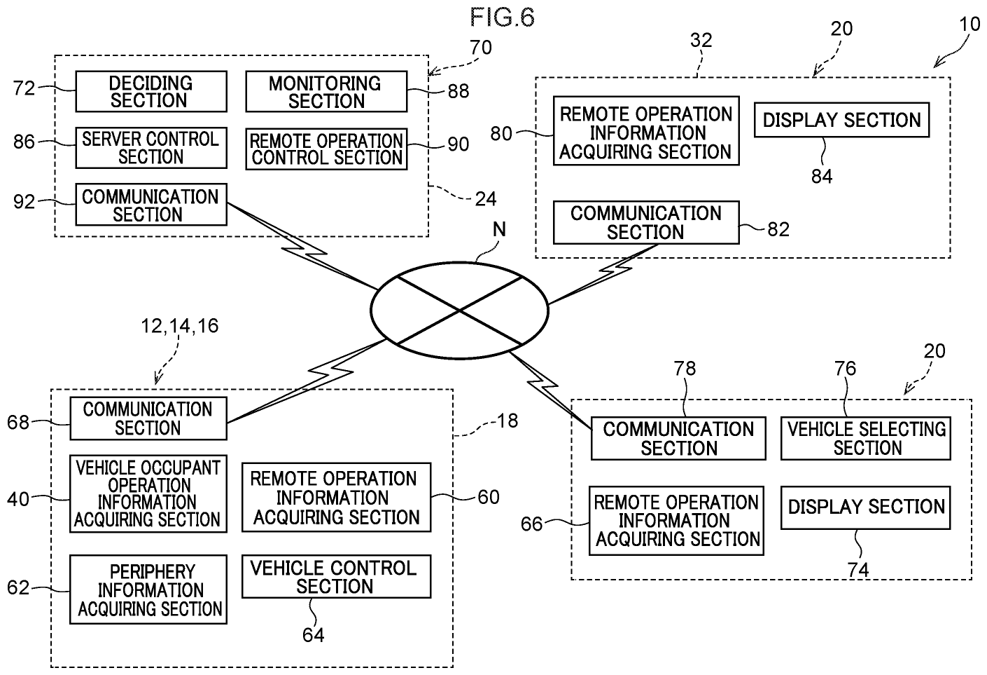

As illustrated in FIG. 1, the vehicle operation system 10 is configured to include onboard devices 18 that are respectively installed in plural vehicles 12, 14, 16, a user terminal device 20, a control center 22, and a server 24. These onboard devices 18, user terminal device 20, control center 22 and server 24 are connected via a network N (see FIG. 6) so as to be able to communicate with one another. The internet, a WAN (Wide Area Network) or the like is used as the network N.

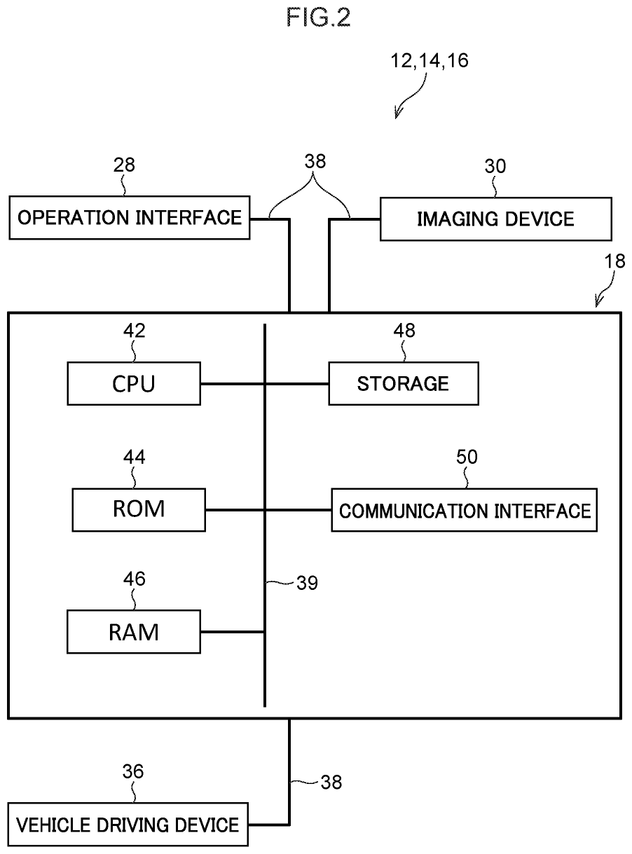

The vehicles 12, 14, 16 may be located at respectively different places. As an example, the vehicle 12 is disposed in advance in an urban area, the vehicle 14 is disposed in advance in a desert region, and the vehicle 16 is disposed in advance on a racing circuit. As an example, the vehicles 12, 14, 16 are vehicles that are owned or managed by a business that manages the vehicle operation system 10, and can be driven manually by operation interfaces 28 within the vehicles (see FIG. 2) and operated remotely from the user terminal device 20 or the control center 22 that uses images of imaging devices 30 (see FIG. 2). Further, the onboard devices 18 can transmit, to the server 24 that is provided at the exterior of the vehicles, the situations of usage of and the vehicle states of the vehicles 12, 14, 16. The concrete configurations and operations of the onboard devices 18 are described later.

The user terminal device 20 is, for example, a smart phone, a cell phone, a tablet, a personal computer, a game terminal or the like, and is possessed by an unillustrated user who is a first operator. The concrete configurations and operations of the user terminal device 20 are described later.

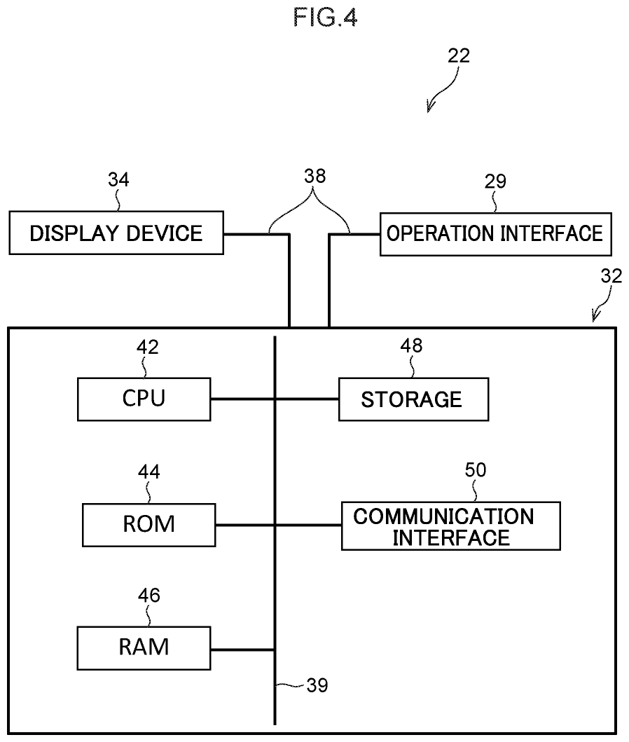

An operation interface 29 for remotely operating the vehicle 12, a remote operation information acquiring device 32, a display device 34 (see FIG. 4), and the server 24 are provided at the control center 22. The server 24 collects various types of information from the onboard devices 18, the user terminal device 20 and the remote operation information acquiring device 32, and manages the collected information as a database, and transmits various types of information. The concrete configurations and operations of the operation interface 29, the remote operation information acquiring device 32, the display device 34 and the server 24 are described later.

As illustrated in FIG. 2, each of the vehicles 12, 14, 16 has the operation interface 28, the onboard device 18, the imaging device 30, and a vehicle driving device 36. These respective configurations are connected via busses 38 so as to be able to communicate with one another.

The operation interface 28 is disposed at the vehicle front side of the vehicle cabin of the vehicle 12, 14, 16, and is configured to include the steering wheel, the acceleration pedal, the brake pedal, and the gear shift lever (none of which is illustrated). The operation interface 28 is connected to a vehicle occupant operation information acquiring section 40 (see FIG. 6) that is at the onboard device 18.

The imaging device 30 is provided, as an example, within the vehicle cabin of the vehicle 12, 14, 16, and captures images of the situation at the exterior of the vehicle, with the front side of the vehicle 12, 14, 16 being the center. The captured images are sent to the onboard device 18.

The onboard device 18 is configured to include a CPU (Central Processing Unit) 42, a ROM (Read Only Memory) 44, a RAM (Random Access Memory) 46, a storage 48, and a communication interface 50. These configurations are connected via a bus 39 so as to be able to communicate with one another.

The CPU 42 is a central computing processing unit, and can execute various types of programs and can control the respective sections. Concretely, the CPU 42 reads-out programs from the ROM 44 or the storage 48, and executes the programs by using the RAM 46 as a workspace. The CPU 42 carries out control of the above-described respective configurations and various types of computational processings in accordance with the programs that are recorded in the ROM 44 or the storage 48. In the present exemplary embodiment, a vehicle operation program is stored in the ROM 44 or the storage 48.

Various types of programs and various types of data are stored in the ROM 44. The RAM 46 temporarily stores programs and data as a workspace. The storage 48 is configured by an HDD (Hard Disk Drive) or an SSD (Solid State Drive), and stores various types of programs including the operating system, and various types of data.

The communication interface 50 is an interface for the onboard device 18 to communicate with the server 24. Standards of, for example, the internet®, FDDI, Wi-Fi® and the like are used at the communication interface 50.

On the basis of control of the onboard device 18, the vehicle driving device 36 operates an unillustrated motor that drive wheels 12A, 14A, 16A (see FIG. 1) of the vehicles 12, 14, 16 respectively.

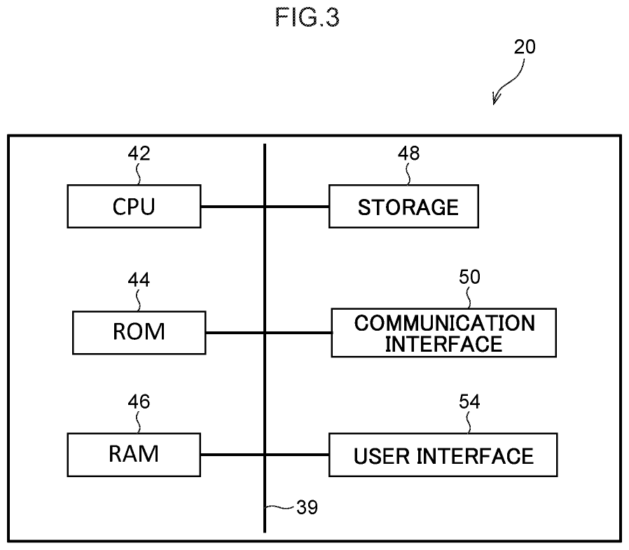

As illustrated in FIG. 3, the user terminal device 20 is configured to include the CPU 42, the ROM 44, the RAM 46, the storage 48, the communication interface 50, and a user interface 54. These respective configurations are connected via the bus 39 so as to be able to communicate with one another. The user interface 54 is the interface at the time when the user selects any of the vehicles 12, 14, 16, and at the time of carrying out display of information that includes images acquired by the vehicle selected from among the vehicles 12, 14, 16, and at the time of carrying out remote operation of that vehicle. Concretely, the user interface 54 is a liquid crystal display having a touch panel that can be operated by touch of a user.

As illustrated in FIG. 4, the operation interface 29, the display device 34 and the remote operation information acquiring device 32 at the control center 22 are connected via the busses 38 so as to be able to communicate with one another. The operation interface 29 is configured of, for example, a keyboard, a mouse, a joystick (none of which is illustrated) and the like, and is provided in order for an unillustrated operator, who is within the control center 22 and is a second operator, to carry out remote operation of the vehicles 12, 14, 16. Note that the operation interface 29 may be configured to include a controller that is modeled after a steering wheel, an acceleration pedal, a brake pedal and a gear shift lever (none of which is illustrated).

The remote operation information acquiring device 32 is configured to include the CPU 42, the ROM 44, the RAM 46, the storage 48 and the communication interface 50. These respective configurations are connected via the bus 39 so as to be able to communicate with one another. The remote operation information acquiring device 32 transmits, to the server 24 (see FIG. 1), operation information for remote operation of the vehicles 12, 14, 16 that is inputted from the operation interface 29.

The display device 34 is a display that displays information received from the server 24. Concretely, information, which includes images of the peripheries of the vehicles 12, 14, 16 that have been acquired by the vehicles 12, 14, 16, can be displayed.

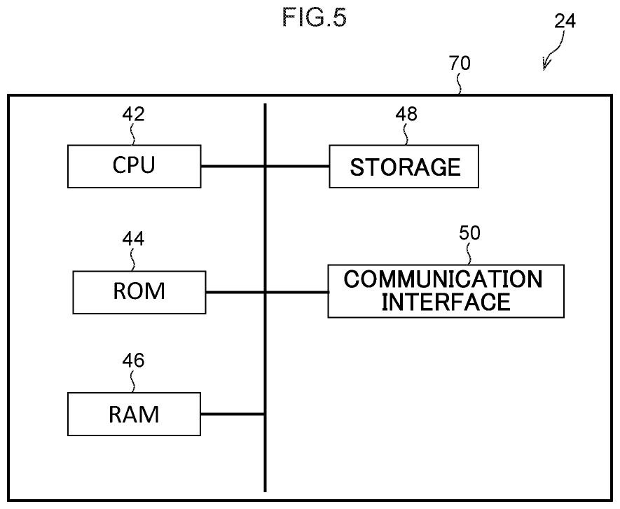

As illustrated in FIG. 5, the server 24 has a remote operation control device 70 that is configured to include the CPU 42, the ROM 44, the RAM 46, the storage 48 and the communication interface 50. These respective configurations are connected via the bus 39 so as to be able to communicate with one another.

At the time of executing the aforementioned vehicle operation program, the vehicle operation system 10 realizes various types of functions by using the above-described hardware resources. The functional configurations that are realized by the vehicle operation system 10 are described hereinafter.

FIG. 6 is a block drawing illustrating an example of the functional configurations of the vehicle operation system 10.

As illustrated in FIG. 6, the vehicle operation system 10 has, as the functional configurations at the respective vehicles 12, 14, 16, the vehicle occupant operation information acquiring section 40, a remote operation information acquiring section 60, a periphery information acquiring section 62 that serves as an acquiring section, a vehicle control section 64, and a communication section 68. These respective functional configurations are realized by the CPU 42 of the onboard device 18 reading-out the vehicle operation program that is stored in the ROM 44 or the storage 48, and executing the program.

The vehicle occupant operation information acquiring section 40 acquires operation information that a vehicle occupant, who is riding in the vehicle 12, 14, 16, inputs to the operation interface 28 (see FIG. 2).

The remote operation information acquiring section 60 controls the communication section 68 so as to obtain operation information that is transmitted from the remote operation control device 70 of the server 24. The operation information, transmitted from the remote operation control device 70, is inputted to the operation interface 29 (see FIG. 4) by an operator of the control center 22, or is inputted to the user terminal device 20 by the user who possesses the user terminal device 20.

The vehicle control section 64 controls the driving of the vehicle driving device 36 (see FIG. 2) on the basis of the operation information acquired by the vehicle occupant operation information acquiring section 40 or the remote operation information acquiring section 60. Note that the vehicle control section 64 controls the vehicle driving device 36 on the basis of operation information to which a deciding section 72, which is described later, has given an operation right that enables operation of the vehicle 12, 14, 16 to be carried out. Namely, in a case in which the operation information to which an operation right is given is acquired from the remote operation information acquiring section 60, the vehicle driving device 36 is controlled on the basis of the operation information from the remote operation information acquiring section 60. Accordingly, in a case in which the vehicle control section 64 acquires operation information simultaneously from the remote operation information acquiring section 60 and the vehicle occupant operation information acquiring section 40, the vehicle driving device 36 is controlled in accordance with the operation information of whichever has been given the operation right.

The periphery information acquiring section 62 acquires various types of information such as images captured by the imaging device 30 (see FIG. 2) provided at the vehicle 12, 14, 16, and, from various unillustrated sensors, the traveling history including dates and times, the total distance traveled, the amount of fuel remaining, the amounts of various oils, the air pressures of the tires, and the like. The periphery information acquiring section 62 controls the communication section 68 to transmit these various types of information to the server 24.

The communication section 68 transmits and receives information to and from other devices.

The vehicle operation system 10 has, as the functional configurations at the user terminal device 20, a remote operation information acquiring section 66, a display section 74, a vehicle selecting section 76, and a communication section 78. These various functional configurations are realized by the CPU 42 of the user terminal device 20 reading-out the vehicle operation program that is stored in the ROM 44 or the storage 48, and executing the program.

The remote operation information acquiring section 66 acquires operation information from the user interface 54 (see FIG. 3), and controls the communication section 78 to transmit this operation information to the server 24.

The display section 74 controls the user interface 54 (see FIG. 3) so as to display, to the user, various types of information that are from the periphery information acquiring section 62 of the vehicle 12, 14, 16 and that have been received from the server 24.

When the user executes the vehicle operation program of the user terminal device 20, the vehicle selecting section 76 sends a request to the server 24 to transmit information of vehicles that can travel among the vehicles 12, 14, 16, and displays to the user various types of information, which are about the vehicles that can travel and which are received from the server 24, and displays the user interface 54 (see FIG. 3) in order for the user to select one of the vehicles. Then, the vehicle selecting section 76 controls the control section to transmit, to the server 24, the results of the user selecting a vehicle by operation of the user interface 54.

The communication section 78 can transmit and receive information to and from other devices.

The vehicle operation system 10 has, as the functional configurations of the control center 22, a remote operation information acquiring section 80, a communication section 82 and a display section 84. These various functional configurations are realized by the CPU 42 of the remote operation information acquiring device 32 reading-out the vehicle operation program that is stored in the ROM 44 or the storage 48, and executing the program.

The remote operation information acquiring section 80 acquires operation information from the operation interface 29 (see FIG. 4), and controls the communication section 82 to transmit that operation information to the server 24.

The display section 84 controls the display device 34 (see FIG. 4) to display, to the operator, various types of information that are from the periphery information acquiring section 62 of the vehicle 12, 14, 16 and that have been received from the server 24.

The communication section 82 transmits and receives information to and from other devices.

The vehicle operation system 10 has, as the functional configurations of the server 24, the deciding section 72, a monitoring section 88, a remote operation control section 90, a server control section 86 serving as an information providing section, and a communication section 92. These various functional configurations are realized by the CPU 42 of the remote operation control device 70 of the server 24 reading-out the vehicle operation program that is stored in the ROM 44 or the storage 48, and executing the program.

The deciding section 72 gives a user or the control center 22 an operation right by which the user or the control center 22 can carry out operation of any of the vehicles 12, 14, 16. Further, the deciding section 72 gives the manager authority to the control center 22. As an example, only one operation right is given at a time to a vehicle, and the control center 22 that has the manager authority can prioritarily transfer that operation right from the user to the control center 22. As an example, in a case in which a user wishes to experience driving in a desert region by remote operation, when the user selects the vehicle 14 (see FIG. 1) from the user terminal device 20, the deciding section 72 determines whether or not that user satisfies a predetermined condition (as an example, whether the user who is a registered member has paid a usage fee), and, if the user does satisfy the predetermined condition, that user is given the operation right of the vehicle 14. Similarly, in a case in which a user wishes to experience driving in an urban area by remote operation, when the user selects the vehicle 12 (see FIG. 1) from the user terminal device 20, the deciding section 72 determines whether or not that user satisfies a predetermined condition, and, if the user does satisfy the predetermined condition, that user is granted an operation right to the vehicle 12. Moreover, in a case in which a user wishes to experience driving on a racing circuit by remote operation, when the user selects the vehicle 16 (see FIG. 1) from the user terminal device 20, the deciding section 72 determines whether or not that user satisfies a predetermined condition, and, if the user does satisfy the predetermined condition, that user is granted an operation right to the vehicle 16. The deciding section 72 transmits, to the remote operation control section 90, information granting the operation right to either the user or the control center 22.

At the time when any of the vehicles 12, 14, 16 is being remotely operated by a user, the monitoring section 88, when determining it to be necessary, prioritarily transfers the operation right of that vehicle 12, 14, 16 to the control center 22 to whom the manager authority has been given. Concretely, in a case in which any of the vehicles 12, 14, 16 drives into an area that is set in advance and where vehicle entry is prohibited, or in a case in which the user ends the remote operation of any of the vehicles 12, 14, 16, or in a case in which the user abandons remote operation in the midst thereof, the monitoring section 88 transfers the operation right of that vehicle 12, 14, 16 to the operator of the control center 22. Note that the monitoring section 88 transmits, to the remote operation control section 90, information that the operation right has been transferred.

Further, when the monitoring section 88 determines it to be necessary, and concretely, in cases in which any of the vehicles 12, 14, 16 drives into an area that is set in advance and where vehicle entry is prohibited, or in a case in which remote operation is abandoned on a road, or in a case in which there is a relatively high degree of urgency such as in a traffic accident or the like, the monitoring section 88 determines that there is a highly precarious situation, and controls the communication section 92 so as to notify to outside, and concretely, the control center 22 and an official body such as the police or the like. Note that “a highly precarious situation” of the vehicle 12, 14, 16 is determined from unillustrated sensors that are provided at the vehicles 12, 14, 16 respectively, or from the contents of the operation information, or the like.

The remote operation control section 90 acquires, from the deciding section 72 and the monitoring section 88, the operation information of whomever has been granted the operation right. Namely, in a case in which an operation right for any of the vehicles 12, 14, 16 has been given to a user by the deciding section 72, the remote operation control section 90 acquires operation information of the remote operation from the user terminal device 20, and adds, to that operation information, information expressing that the operation right has been given. Further, in a case in which information that the operation right has been transferred by the monitoring section 88 to the operator of the control center 22 is received, the remote operation control section 90 acquires operation information of the remote operation from the remote operation information acquiring section 80 of the control center 22, and adds, to that operation information, information expressing that the operation right has been given. Then, the remote operation control section 90 controls the server control section 86 so that operation information, which is for remote operation and to which information expressing that the operation right has been given is added, is transmitted to the vehicle 12, 14, 16.

The server control section 86 controls the server 24. For example, the server control section 86 acquires various types of information transmitted from the vehicles 12, 14, 16, and searches for a vehicle that can travel from that information, and controls the communication section 92 to transmit that information to the control center 22 or the user terminal device 20. Further, the server control section 86 transmits, to the deciding section 72, the monitoring section 88 and the remote operation control section 90, various types of information that are acquired from the vehicles 12, 14, 16, the user terminal device 20 and the control center 22, and controls the communication section 92 such that various types of information from the deciding section 72, the monitoring section 88 and the remote operation control section 90 are transmitted to the vehicles 12, 14, 16 and the control center 22. Further, in a case in which an operation right has been granted to a user, the server control section 86 controls the communication section 92 to transmit the various types of information acquired from the vehicle 12, 14, 16 also to the user terminal device 20 of that user.

The communication section 92 transmits and receives information to and from other devices.

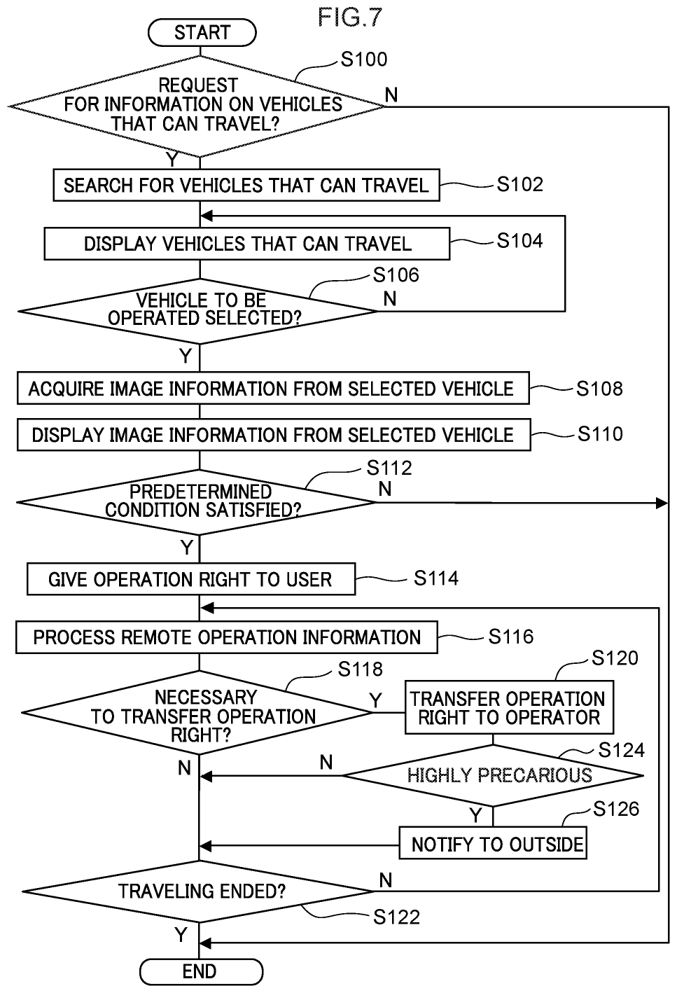

Operation of the vehicle operation system 10 is described next. FIG. 7 is a flowchart illustrating the flow of operations by the vehicle operation system 10. Processing is carried out by the respective CPUs 42 of the onboard devices 18, the user terminal device 20, the remote operation information acquiring device 32 and the remote operation control device 70 reading-out the vehicle operation program from the ROMs 44 or the storages 48, and expanding the executing the program in the RAMs 46.

The CPU 42 determines whether or not information on vehicles that can travel has been requested from the user terminal device 20 (step S100). If information on vehicles that can travel has not been requested from the user terminal device 20 (step S100: NO), the CPU 42 ends the processing that is based on the vehicle operation program. On the other hand, if information on vehicles that can travel has been requested from the user terminal device 20 (step S100: YES), the CPU 42 acquires various types of information of the respective vehicles 12, 14, 16 and searches for a vehicle that can travel (step S102).

The CPU 42 displays the vehicles, which can travel and that have been found, on the user interface 54 of the user terminal device 20 (step S104). Then, the CPU 42 determines whether or not the user has selected and inputted, to the user interface 54, one vehicle that the user wishes to remotely operate from among the vehicles that can travel (step S106). If the user has not selected and inputted one vehicle that he/she wishes to remotely operate (step S106), the CPU 42 returns to the processing of step S104. On the other hand, if the user has selected and inputted one vehicle that he/she wishes to remotely operate (step S106), the CPU 42 acquires various types of information, which include images capturing the situation at the periphery of the vehicle 12, from the selected vehicle 12. (Hereinafter, as an example, it is assumed that the user selects the vehicle 12.) Then, the CPU 42 displays the various types of information acquired from the vehicle 12 on the user interface 54 of the user terminal device 20 (step S110).

The CPU 42 determines whether or not a predetermined condition, such as, for example, whether the user has paid a usage fee, or the like, is satisfied (step S112). If this predetermined condition is not satisfied (step S112), the CPU 42 ends the processing that is based on the vehicle operation program. On the other hand, if the predetermined condition has been satisfied (step S112), the CPU 42 gives the user an operation right that enables the user to operate the vehicle 12 (step S114). Then, the CPU 42 processes the remote operation information, which is inputted by the user to the user interface 54 of the user terminal device 20, and operates the vehicle 12 (step S116).

The CPU 42 monitors the state of the vehicle 12, and determines whether or not the operation right that has been granted to the user needs to be transferred to the control center 22 (step S118). If a transfer of the operation right is unnecessary (step S118), the CPU 42 determines whether or not traveling of the vehicle 12 has ended (step S122). If traveling of the vehicle 12 has ended (step S122), the CPU 42 ends the processing that is based on the vehicle operation program. On the other hand, if traveling of the vehicle 12 has not ended (step S122), the CPU 42 returns to step S116.

If there is a need to transfer the operation right that has been granted to the user (step 11), the CPU 42 transfers the operation right to the control center 22 (step S120). Then, the CPU 42 determines whether or not the vehicle 12 is in a highly precarious situation (step S124). If the vehicle 12 is not in a highly precarious situation (step S124), the CPU 42 proceeds to step S122. On the other hand, if the vehicle 12 is in a highly precarious situation (step S124), the CPU 42 notifies to the outside (step S126) and proceeds to step S122.

Operation of the present exemplary embodiment are described next.

In the present exemplary embodiment, as illustrated in FIG. 6, the vehicle operation system 10 has the plural vehicles 12, 14, 16, the periphery information acquiring section 62, the deciding section 72, the server control section 86, the remote operation control section 90, and the monitoring section 88. The plural vehicles 12, 14, 16 are respectively located at plural places. The periphery information acquiring section 62 acquires information including images of the situations of the peripheries of the respective vehicles 12, 14, 16. The deciding section 72 allows either a user or an operator of the control center 22 to operate the vehicle 12, 14, 16. At least one of the user and the operator of the control center 22 operates any of the vehicles 12, 14, 16 by remote operation via the remote operation control section 90. In a case in which the user or the operator of the control center 22 who has been allowed by the deciding section 72 carries out operation of any of the vehicles 12, 14, 16 by remote operation, the server control section 86 provides the remote operator with the information of the periphery of the vehicle 12, 14, 16 that the periphery information acquiring section 62 acquires. Due thereto, at the time when a user or an operator of the control center 22 carries out remote operation, the vehicle 12, 14, 16 can be operated while the situation at the periphery of the vehicle 12, 14, 16 is known. Due thereto, the user can easily have the experience of driving in various places such as an urban area, a desert region, a racing circuit or the like, without actually traveling to such a place.

Further, at a time of remote operation of any of the vehicles 12, 14, 16 by either of a user or an operator of the control center 22, the monitoring section 88, when determining that such is necessary, transfers the operation right of the vehicle 12, 14, 16 to the other of the user and the operator of the control center 22. Accordingly, at the time of remote operation by either one of a user and an operator of the control center 22, in a case in which a state arises in which remote operation of the vehicle 12, 14, 16 cannot be carried out, or in a case in which a precarious arises such as the vehicle 12, 14, 16 drives into a precarious area or the like, the vehicle 12, 14, 16 can be operated appropriately by the other of the user and the operator of the control center 22. Due thereto, the remotely-operated vehicle 12, 14, 16 falling into a precarious situation may be suppressed.

Moreover, the monitoring section 88 prioritarily transfers the operation right of the vehicle 12, 14, 16 to the control center 22 that has been given the manager authority among the user and the control center 22. Therefore, when the vehicle 12, 14, 16 falls into a precarious situation at the time of remote operation, the operator of the control center 22, who has the manager authority, can operate the vehicle 12, 14, 16. Accordingly, the vehicle 12, 14, 16 can be set in a more appropriate state. Due thereto, managing of the vehicles 12, 14, 16 is easy.

Furthermore, when the monitoring section 88 determines that the vehicle 12, 14, 16 is in a highly precarious situation, the monitoring section 88 notifies to the outside. Therefore, it is easy to receive notifications and to change the vehicle 12, 14, 16 over to an appropriate state. Namely, it is possible to suppress the continuing of a precarious situation precarious situation at the vehicle 12, 14, 16. Due thereto, the remotely-operated vehicle 12, 14, 16 falling into a precarious situation precarious situation may be reduced even more.

Note that, in the present exemplary embodiment, the manager authority is given to the control center 22. However, the present disclosure is not limited to this. A manager authority may not be set, and the operation right may be transferred by the users. Further, although a case in which the control center 22 and the user respectively operate the vehicle 12, 14, 16 by remote operation, has been described, the present disclosure is not limited to this. Either one of the control center 22 and the user may carry out operation by the operation interface 28 (see FIG. 2) that is within the vehicle. Further, the operation right may be given to the operation interface 28 that is within the vehicle. Due thereto, there may be a configuration in which, while operations are instructed by remote operation from the control center 22, the user manually operates the operation interface 28 of the vehicle 12, 14, 16, or, conversely, an operator at the business side manually operates the operation interface 28 of the vehicle 12, 14, 16 and a user operates the vehicle 12, 14, 16 by remote operation. Further, the above-described configurations may be applied to instructional services that teach users how to improve their ways of operating the vehicles 12, 14, 16 and/or their driving skills.

Moreover, in addition to images captured by the imaging device 30 of the vehicle 12, 14, 16, environment information such as a crosswind that hits the vehicle 12, 14, 16 or the air temperature or the like, or information such as the amount of fuel, the amount of oil, the temperature and the like of the vehicle 12, 14, 16, may be provided to the operator who carries out the remote operation.

Moreover, the monitoring section 88 is configured so as to notify to the outside when it is determined that there is a highly precarious situation at the vehicle 12, 14, 16. However, the present disclosure is not limited to this, and may be configured such that notification is not carried out.

Although a case in which the operation right of the vehicle 12, 14, 16 is transferred to another operator by the deciding section 72 and the monitoring section 88, has been described, the present disclosure is not limited to this. A manager, who carries out managing, may transfer the operation right.

Moreover, in the above, although the vehicles 12, 14, 16 are located in an urban area, in a desert region and on a racing circuit, the present disclosure is not limited to this. The vehicles may be located in various places other than these, or the number of vehicles may be increased and the vehicles located in various places.

Still further, although a case in which the operation interface 28 (see FIG. 2) is provided within each of the vehicles 12, 14, 16 such that manual operation is possible, has been described, the present disclosure is not limited to this. The vehicles may be configurations such as so-called radio-controlled cars that do not have the operation interfaces 28 and are operated only by remote operation.

Although an exemplary embodiment of the present disclosure have been described, the present disclosure is not limited to the above, and can, of course, be implemented by being modified in various ways other than the above within a scope that does not depart from the gist thereof.

What is claimed is:

1. A vehicle operation system comprising:
a plurality of vehicles that are respectively located at a plurality of places;
an acquiring section configured to acquire information of the vehicles including images of peripheries of the vehicles;
a deciding section configured to set an operation right to enable operation of the vehicle, for either a first operator or a second operator that carries out operation of the vehicle by remote operation;
an information providing section configured to, in a case in which the first operator or the second operator, for whom the operation right has been set by the deciding section, carries out operation of the vehicle by remote operation, provide the information acquired by the acquiring section to the first operator or the second operator who has been given the operation right;
a remote operation control section configured to, in a case in which the first operator or the second operator, for whom the operation right has been set by the deciding section, carries out operation of the vehicle by remote operation, causes the vehicle to operate by remote operation by operation of the first operator or the second operator; and
a monitoring section configured to, at a time of remote operation of the vehicle by the first operator or the second operator, transfers the operation right to another of the first operator and the second operator when determined necessary.

2. The vehicle operation system of claim 1, wherein:
the deciding section is further configured to set a manager authority for either one of the first operator and the second operator, and
the monitoring section is further configured to prioritize transfer of the operation right of the vehicle to the one of the first operator and the second operator who has been given the manager authority.

3. The vehicle operation system of claim 1, wherein the monitoring section notifies an outside when determining it to be necessary.
